(19) United States
(12) Patent Application Publication
(10) Pub. No.: US 2017/0328090 A1
(43) Pub. Date: Nov. 16, 2017

(54) MERCHANDISE SECURITY CONTAINER WITH ADJUSTABLE LOCK

(71) Applicant: InVue Security Products Inc., Charlotte, NC (US)

(72) Inventors: Andrew Moock, Brecksville, OH (US); Christopher J. Fawcett, Charlotte, NC (US)

(21) Appl. No.: 15/592,817

(22) Filed: May 11, 2017

Related U.S. Application Data
(60) Provisional application No. 62/336,028, filed on May 13, 2016.

(51) Int. Cl. E05B 73/00; A47F 7/024; A47F 7/03; B65D 77/22

(52) U.S. Cl. CPC E05B 73/0023; B65D 77/22; A47F 7/024; A47F 7/03

(57) ABSTRACT

A merchandise security device is provided. The merchandise security device may include a lock mechanism operably engaged with a container. The lock mechanism may be configured to be removably attached to the container and to secure the item of merchandise within the container. In addition, the lock mechanism may be adjustable in length.

### CROSS REFERENCE TO RELATED APPLICATIONS

This application claims the benefit to priority of U.S. Provisional Patent Application No. 62/336,028 filed on May 13, 2016, the entire disclosure of which is incorporated herein by reference.

### FIELD OF THE INVENTION

Embodiments of the present invention relate generally to merchandise display security devices and methods for protecting an item of merchandise from theft.

### BACKGROUND OF THE INVENTION

It is common practice for retailers to store and/or display relatively expensive items of merchandise on or within a merchandise security device, such as a security display (e.g. alarming stand), security fixture (e.g. locking hook, shelf, cabinet, etc.) or security packaging (e.g. merchandise safer). Regardless, the merchandise security device displays and/or stores an item of merchandise so that a potential purchaser may view, and in some instances, interact with the merchandise before making a decision whether to purchase the item. At the same time, the item is secured on or within the merchandise security device so as to prevent, or at least deter, theft of the item. The value of the item, however, may make it an attractive target for a shoplifter despite the presence of a merchandise security device. A determined shoplifter may attempt to detach the item from the security display, or attempt to remove the item from the security fixture or from the security packaging. Alternatively, the shoplifter may attempt to remove the security device, or at least a portion thereof, from the display area along with the item.

### BRIEF SUMMARY

Embodiments of the present invention are directed towards merchandise security devices, merchandise security systems, and methods for protecting items of merchandise from theft. In one embodiment, a merchandise security device includes a container comprising an interior compartment for receiving an item of merchandise therein and a lock mechanism configured to be removably attached to the container and to secure the item of merchandise within the container. The lock mechanism is adjustable in length.

In another embodiment, a merchandise security system includes a plurality of containers each comprising an interior compartment for receiving an item of merchandise therein. The plurality of containers are different sizes from one another. The merchandise security system also includes a lock mechanism configured to be removably attached to one of the containers and to secure the item of merchandise within the container, wherein the lock mechanism is adjustable in length.

In one embodiment, a method includes selecting one of a plurality of different sized containers, wherein each container comprises an interior compartment for receiving an item of merchandise therein. The method further includes adjusting a length of a lock mechanism and attaching the lock mechanism to the selected container to secure the item of merchandise within the container.

### BRIEF DESCRIPTION OF THE DRAWINGS

FIG. 1 is a perspective view of a merchandise security device according to one embodiment of the present invention.

### DETAILED DESCRIPTION OF EMBODIMENTS OF THE INVENTION

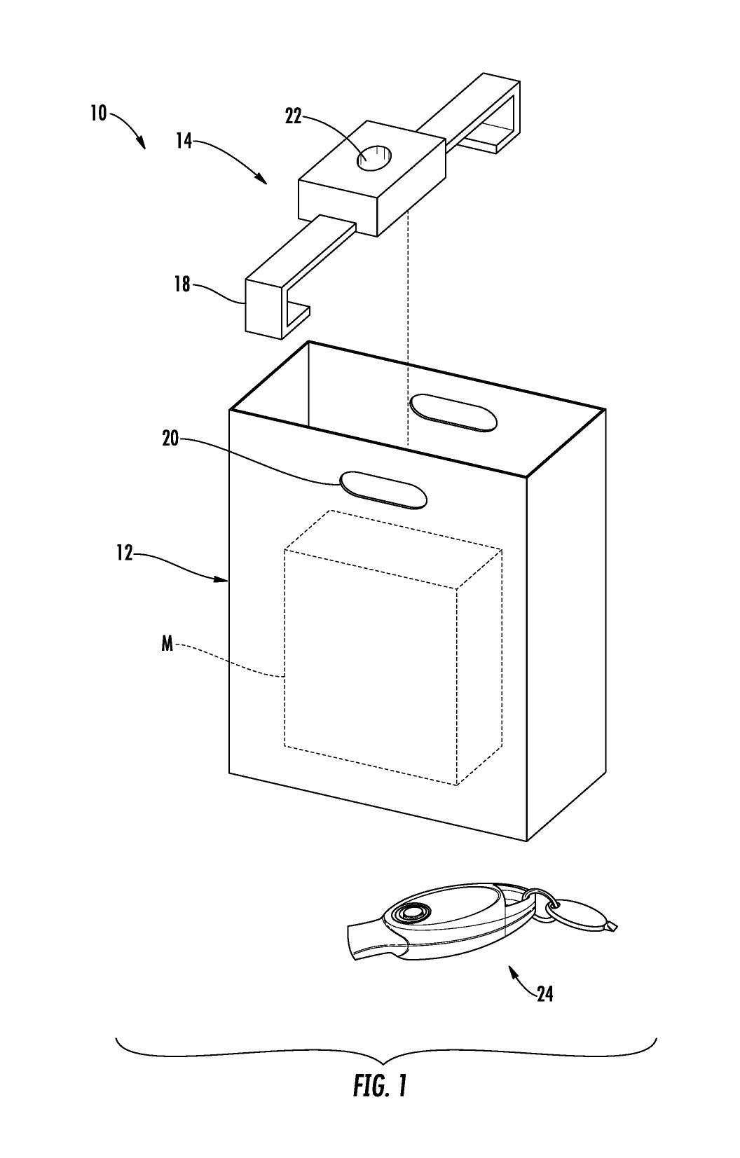

Referring now to the accompanying drawing figures wherein like reference numerals denote like elements throughout the various views, one or more embodiments of a merchandise display security device are shown. FIG. 1 illustrates a merchandise security device 10 according to one embodiment of the invention. The security device 10 includes a container or housing 12 defining a generally hollow interior compartment configured to receive an item of merchandise M therein. The security device 10 also includes a lock mechanism 14 configured to engage the container 12.

The lock mechanism 14 may be configured to removably engage the housing 12. When the lock mechanism 14 is engaged with the housing 12, the item of merchandise cannot be removed from the housing without damaging the security device 10 or removing the lock mechanism. In some embodiments, the lock mechanism 14 comprises one or more engagement features 18 (e.g., arms, pins, protrusions, or the like) and the housing 12 comprises a plurality of retaining features 20 (e.g., holes, openings, slots, or the like), and each of the engagement features is configured to engage a respective retaining feature for securing the lock mechanism to the housing. Thus, when the engagement features 18 are engaged with the retaining features 20, the lock mechanism 14 cannot be removed from the housing 12 without first unlocking the lock mechanism. The engagement features 18 and retaining features 20 may be arranged in any suitable manner and include any desired number. In the illustrated embodiment, the retaining features 20 are disposed on a front surface of the housing 12 and a rear surface of the housing and may be aligned with one another along a linear axis. Similarly, the engagement features 18 may extend along a linear axis for engaging each of the retaining features 20. FIG. 1 shows that the engagement features 18 may have a C-shaped cross section. It is understood that the engagement features 18 and corresponding retaining features 20 may have any desired shape (e.g., rectangular or circular in cross section) and that the engagement features may have a variety of sizes and configurations suitable for engaging correspondingly shaped retaining features defined in the housing 12. Moreover, the lock mechanism 14 may have any desired width for blocking or at least covering the opening of the container 12. For instance, the lock mechanism 14 may not cover the entire opening of the container 12 as long as the merchandise cannot be removed. When the lock mechanism 14 is removed, the retaining features 20 may be configured to receive a rod therethrough for hanging one or more of the security devices 10 on the rod in a display orientation.

The housing 12 may be formed of any desired material such as a clear polymeric material so that an item of merchandise can be seen through the housing. The housing 12 may be any desired shape, such as a housing with a bottom surface and four sidewalls extending from the bottom surface to an open end. In addition, the housing may include a tapered wall thickness. For example, the sidewall thickness may increase progressively from the bottom surface towards the open end. The tapering sidewalls may be the front and rear sidewalls, while the lateral sidewalls are uniform in thickness. However, the entire sidewall may be tapered in some embodiments. In one non-limiting example, the sidewall thickness increases from about 2 mm to about 3 mm, with a draft of about 0.25 degrees on one surface and about 0.5 degrees on the opposing surface. The increased wall thickness may provide for more robust engagement between the engagement features and the retaining features. It is noted that use of the terms “bottom”, “front”, “rear”, and “top” are not intended to be limiting and will depend on the orientation of the security device. In addition, it is understood that the top and/or bottom edges or surfaces may include flat or curved surfaces. Flat surfaces on one or both of the top and bottom surfaces may facilitate stacking for storage when the security devices are not in use.

In one embodiment, the lock mechanism 14 is adjustable. For example, a distance between the engagement features 18 may be configured to be increased or decreased depending on the size of the housing 12. Thus, the lock mechanism 14 may be configured to accommodate different sized housings 12 which may each have a different sized opening. In some cases, the lock mechanism 14 includes a pair of engagement features 18 configured to move relative to one another, such as a pair of arms configured to be moved towards and away from one another. The lock mechanism 14 may include a lock 22 for securing the pair of engagement features 18. As such, the engagement features 18 may be adjusted to a desired position and engage the retaining features 20 and then the lock mechanism may be locked so that the engagement features cannot be moved or removed from the retaining features without unlocking the lock 22. In the illustrated embodiment, each engagement feature 18 may be configured to be inserted from an outer surface of the housing 12 and through a respective retaining feature 20. Thus, each engagement feature 18 may be inserted at least partially through a sidewall of the housing 12.

The lock 22 may be any suitable mechanism configured to secure the engagement features 18 relative to one another. For example, a fastener could be used in some cases. In other cases, a key 24 may be required in order to lock and/or unlock the lock 22. In some embodiments, a mechanical, magnetic, or electronic key 24 may be used to lock and/or unlock the lock 22. Moreover, the engagement features 18 may have characteristics that facilitate fixation therebetween, such as a plurality of corresponding notches or ridges that are configured to engage with one another when the lock is actuated to thereby prevent the engagement features from being disengaged from one another.

Any number of lock mechanisms 14 may be employed in conjunction with various forms of power transfer for actuating a lock 22 (e.g., electrical, inductive, capacitive, etc.). For example, where a shape memory material is utilized, a change in shape of the shape memory material may cause mechanical actuation (e.g., linear and/or rotary movement) of the lock 22. The shape memory material may be operably engaged with a lock 22 in any number of configurations to facilitate such actuation. Moreover, the shape memory material may be any suitable material, such as a metal, a polymer, or a combination thereof, that is configured to change its shape (e.g., length, area, etc.) in response to an electric current or a change in temperature and to return to its original shape after the electric current is no longer transferred therethrough. For example, transferring current through the shape memory material may cause the material to be heated and thereby contract. Upon removal of the current, the shape memory material may return to its original shape. In addition, other mechanisms may be utilized for actuating a lock 22, including mechanical, electrical, and/or chemical state changes. As such, the security devices 10 and associated lock mechanisms 14 should not be limited in light of the embodiments shown and described herein.

In one embodiment, the merchandise display security device 10 is configured to be operated with an electronic key. The electronic key may be useable with any security device 10 that utilizes power transferred from the key to operate a mechanical lock mechanism 14 associated with the security device, and/or utilizes data transferred from the key to authorize the operation of a mechanical lock mechanism or an electronic alarm circuit. In other words, an electronic key according to embodiments of the invention is useable with any security device 10 or lock mechanism 14 that requires power transferred from the key to the device and/or data transferred between the key and the device. In some embodiments, power is transferred via inductance or electrical contacts, although any desired power transfer means may be used.

In certain embodiments, the merchandise security device 10 is a passive device. As used herein, the term “passive” is intended to mean that the security device 10 does not have an internal power source (e.g., a battery) sufficient to lock and/or unlock a mechanical lock mechanism 14. In addition, the security device 10 may not require an electric motor, such as a DC stepper motor, solenoid, or the like, that is configured to lock or unlock the lock mechanism 14. As such, the security device 10 may employ a simplified lock mechanism 14 that does not require various components operated by its own source of electrical power.

Moreover, in certain embodiments the merchandise security device 10 is not required to include a logic control circuit, while the electronic key includes such a logic control circuit. In this regard, some security devices 10 include a logic control circuit adapted to perform a handshake communication protocol with the logic control circuit of the electronic key (e.g., using a security disarm code or SDC). Thus, the security device 10 may or may not include a logic control circuit used to communicate with the electronic key in order to determine whether the merchandise security device is an authorized device. Likewise, the electronic key may or may not include a logic control circuit. Regardless of whether the electronic key includes a logic control circuit, an SDC may be unnecessary where the electronic key configured to transmit power to the security device 10 is not readily duplicated by a potential thief. For example, where the electronic key is configured to transmit power inductively, the inductive signature may provide increased security relative to conventional lock mechanisms that utilize mechanical or magnetic actuators. For instance, the electronic key may be configured to transmit an inductive signature including a particular amplitude and/or frequency of a power signal that is not readily apparent to, or is not readily able to be duplicated by, a potential thief.

In some embodiments, the electronic key does not transmit an SDC to the security device 10. However, in other embodiments, the electronic key may be configured to transmit an SDC to the security device. In the latter embodiments, the security device may include a corresponding SDC. Thus, the electronic key may be configured to perform a handshake communication protocol with the security device. In the event that the SDC of the electronic key matches the SDC of the security device, the electronic key may then be configured to transmit electrical power to the security device 10. In other cases, the electronic key may transfer power to the security device 10, and if the SDC of the electronic key matches the SDC of the security device, the electronic key may operate the security device. As will be readily apparent to those skilled in the art, the SDC may be transmitted from the electronic key to the merchandise security device by any suitable means, including without limitation, via one or more electrical contacts, or via optical, acoustic, electromechanical, electromagnetic or magnetic conductors, as desired. In certain embodiments, the SDC may be transmitted by inductive transfer of data from the electronic key to the merchandise security device.

In one embodiment, the logic control circuit of the electronic key is configured to cause the internal power source of the key to transfer electrical power to the security device to operate a lock mechanism 14 of the security device. In one example, electrical contacts disposed on the electronic key electrically couple with cooperating electrical contacts on the merchandise security device 10 to transfer power from the internal battery of the key to the merchandise security device. As such, electrical power may be transferred directly to the lock mechanism 14 via one or more conductors. For example, a conductor may be coupled to a mechanical lock mechanism 14 and when electrical power is conducted through the conductor a state change occurs, thereby resulting in operation of the lock mechanism. In one embodiment, the conductor is coupled to a shape memory material (e.g., Nitinol) such that electrical power transferred through the conductor results in a change in shape of the shape memory material. Such a change in shape may cause a mechanical actuation (e.g., linear, rotary, etc.) of the lock mechanism 14 to lock or unlock the lock mechanism. In other embodiments, the conductor may couple with a motor or solenoid for operating the lock mechanism 14.

According to one aspect, the electronic key does not require a physical force to be exerted by a user on the key to operate the lock mechanism 14 of the merchandise security device. By extension, no physical force is exerted by the electronic key on the lock mechanism 14. As a result, the electronic key cannot be unintentionally broken off in the lock, as often occurs with conventional mechanical key and lock mechanisms. Furthermore, neither the electronic key nor the lock mechanism 14 suffer from excessive wear as likewise often occurs with conventional mechanical key and lock mechanisms, and to a lesser extent, with electronic key and lock mechanisms having exposed electrical contacts.

The foregoing has described one or more exemplary embodiments of a merchandise display security device and method. Embodiments of a merchandise display security device have been shown and described herein for purposes of illustrating and enabling one of ordinary skill in the art to make, use and practice the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

That which is claimed is:

1. A merchandise security device for protecting items of merchandise from theft, the merchandise security device comprising:
a container comprising an interior compartment for receiving an item of merchandise therein; and
a lock mechanism configured to be removably attached to the container and to secure the item of merchandise within the container,
wherein the lock mechanism is adjustable in length.

2. The merchandise security device of claim 1, wherein the container comprises a plurality of retaining features, and wherein the lock mechanism is configured to engage each of the retaining features.

3. The merchandise security device of claim 2, wherein each of the retaining features comprises an opening defined through a sidewall of the container.

4. The merchandise security device of claim 2, wherein one of the retaining features is defined in a front sidewall of the container and another of the retaining features is defined in a rear sidewall of the container.

5. The merchandise security device of claim 2, wherein the lock mechanism comprises a plurality of engagement features configured to engage a respective one of the retaining features.

6. The merchandise security device of claim 5, wherein each of the engagement features has a C-shaped cross section.

7. The merchandise security device of claim 5, wherein the engagement features comprises a pair of arms movable relative to one another.

8. The merchandise security device of claim 7, further comprising a lock configured to fix the arms relative to one another.

9. The merchandise security device of claim 7, wherein the pair of arms are movable towards and away from one another.

10. The merchandise security device of claim 1, wherein the container comprises a plurality of sidewalls and an opening configured to receive the item of merchandise, and wherein the lock mechanism is configured to extend across the opening to prevent the item of merchandise from being removed from the container.

11. A merchandise security system for protecting items of merchandise from theft, the merchandise security system comprising:
a plurality of containers each comprising an interior compartment for receiving an item of merchandise therein, the plurality of containers being different sizes from one another; and
a lock mechanism configured to be removably attached to one of the containers and to secure the item of merchandise within the container,
wherein the lock mechanism is adjustable in length.

12. The merchandise security system of claim 11, wherein each of the plurality of containers comprises a plurality of retaining features, and wherein the lock mechanism is configured to engage each of the retaining features.

13. The merchandise security system of claim 12, wherein each of the retaining features comprises an opening defined through a sidewall of the container.

14. The merchandise security system of claim 12, wherein the lock mechanism comprises a plurality of engagement features configured to engage a respective one of the retaining features.

15. The merchandise security system of claim 11, wherein each of the plurality of containers comprises a plurality of sidewalls and an opening configured to receive the item of merchandise, and wherein the lock mechanism is configured to extend across the opening to prevent the item of merchandise from being removed from the container.

16. The merchandise security system of claim 15, wherein each of the plurality of containers comprises a different sized opening.

17. A method for protecting items of merchandise from theft, the method comprising:
selecting one of a plurality of different sized containers, each container comprising an interior compartment for receiving an item of merchandise therein;
adjusting a length of a lock mechanism; and
attaching the lock mechanism to the selected container to secure the item of merchandise within the container.

18. The method of claim 17, further comprising unlocking the lock mechanism and removing the lock mechanism from the selected container.

19. The method of claim 17, wherein attaching the lock mechanism comprises engaging the lock mechanism with an opening defined in a sidewall of the selected container.

20. The method of claim 17, wherein attaching the lock mechanism comprises attaching the lock mechanism to the selected container such that that lock mechanism extends across an opening of the selected container to prevent the item of merchandise from being removed from the selected container.
